(19) United States
(12) Patent Application Publication
(10) Pub. No.: US 2006/0042488 A1
(43) Pub. Date: Mar. 2, 2006

(54) Inking device for printing roller for flexographic rotogravure or offset printing

(75) Inventor: Federico D'Annunzio, Cislago (IT)

Correspondence Address: MODIANO & ASSOCIATI, Via Meravigli, 16, MILAN, IT

(73) Assignee: GIDUE S.p.A.

(21) Appl. No.: 11/213,980

(22) Filed: Aug. 30, 2005

(30) Foreign Application Priority Data
Sep. 2, 2004 (IT) MI2004A001693

(51) Int. Cl. B41F 31/14

(52) U.S. Cl. 101/348

(57) ABSTRACT

An inking device for a printing roller for flexographic, rotogravure or offset printing, comprising an ink container with a closed doctor, and a printing roller onto which the ink is to be transferred from the ink container, the device further comprising, within the ink container with closed doctor, a rubber roller, which is meant to make contact with the printing roller in order to transfer controlled doses of ink to cells formed on the surface of the printing roller.

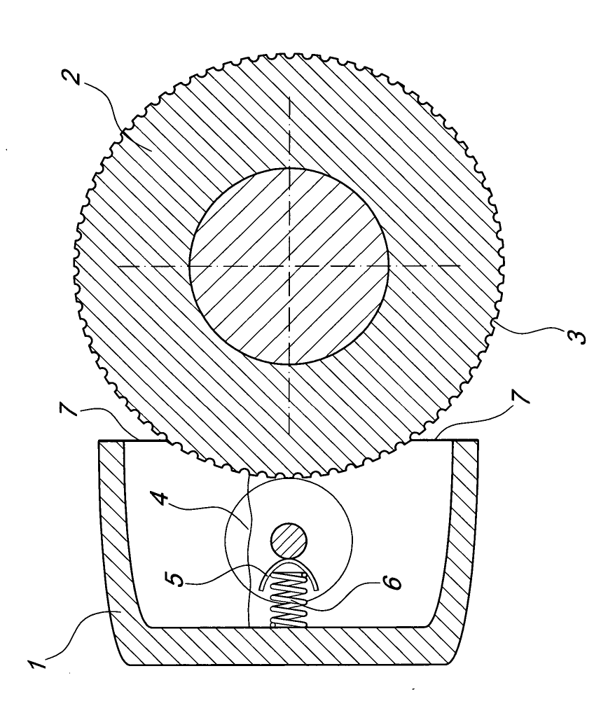

The present invention relates to an inking device for a printing roller for flexographic, rotogravure or offset printing. More particularly, the invention relates to an inking device for an anilox roller or rotogravure roller for a flexographic, rotogravure or offset printing unit.

### BACKGROUND OF THE INVENTION

As is known, in flexographic or rotogravure printing a device is provided for inking the anilox roller or rotogravure roller.

In particular, for example in flexographic printing, a rubber roller is used which is placed in contact with the anilox roller. The rubber roller is turned within an ink reservoir and coated with ink. The rubber roller is configured so as to rotate in contact with the anilox roller.

Transfer of the ink from the rubber roller to the anilox roller occurs by transferring the ink from the rubber roller to cells formed on the outer surface of the anilox roller.

The ink is distributed in the cells by the pressure generated at the point of contact between the rubber roller and the anilox roller.

The pressure generated by the interaction of these rollers is an extremely important factor in order to be able to appropriately dose the amount of ink in the cells of the anilox roller and finally therefrom to the actual printing roller, around which the medium to be printed passes.

Dosage of the ink to the cells of the anilox roller is, as mentioned, extremely important, since if too much ink is sent to the cells, the printing plate is inked excessively, whereas in the opposite case, if the cells are filled with ink in insufficient quantity, an acceptable image will not form on the medium.

Closed doctors are known which are arranged at the ends of an ink container in which the anilox roller or rotogravure roller is immersed. These closed doctors allow to eliminate from the anilox roller the excess ink, which falls back into the ink container. However, this solution does not allow to achieve perfect adhesion of the ink to the anilox roller, since the ink is often highly viscous and therefore the rotation of the anilox roller within the ink container does not allow optimum inking of the surface of the anilox roller.

### SUMMARY OF THE INVENTION

The aim of the present invention is to provide an inking device for an anilox roller or rotogravure or offset roller that allows to achieve optimum inking of the anilox roller when said anilox roller turns within the ink container.

Within this aim, an object of the present invention is to provide an inking device that allows to maintain a substantially constantly optimum pressure between the rubber roller and the anilox roller or rotogravure roller.

Another object of the present invention is to provide an inking device in which the rubber roller can transfer adequately the optimum ink content to the cells of the anilox roller or rotogravure roller.

Another object of the present invention is to provide an inking device in which the filling of the cells of the anilox roller or rotogravure roller occurs independently of the viscosity of the ink.

Another object of the present invention is to provide an inking device that allows to eliminate substantially the influence of air bubbles in the ink as regards final printing, as well as the so-called ghosting effect caused by non-optimum filling of the cells of the anilox roller or rotogravure roller.

Another object of the present invention is to provide an inking device that is highly reliable, relatively easy to manufacture and at competitive costs.

This aim and these and other objects that will become better apparent hereinafter are achieved by an inking device for a printing roller for flexographic, rotogravure or offset printing, comprising an ink container with a closed doctor, and a printing roller onto which the ink is to be transferred from said ink container, characterized in that it comprises, within said ink container with closed doctor, a rubber roller, which is designed to make contact with said printing roller in order to transfer controlled doses of ink to cells formed on the surface of said printing roller.

### BRIEF DESCRIPTION OF THE DRAWING

Further characteristics and advantages of the invention will become better apparent from the description of a preferred but not exclusive embodiment of the inking device according to the invention, illustrated by way of non-limiting example in the accompanying drawing, wherein the only Figure illustrates schematically the inking device.

### DESCRIPTION OF THE PREFERRED EMBODIMENTS

With reference to the figure, the inking device according to the present invention comprises an ink container 1 with closed doctor, which is adapted to contain the ink to be transferred to an anilox roller or rotogravure roller 2, on the outer surface of which a plurality of cells 3 designed to be filled by the ink transferred by the inking device are provided.

A rubber roller 4 is accommodated advantageously within the container 1 with closed doctor. The rotation of the rubber roller 4 transfers ink to the cells 3 of the roller 2.

In order to always ensure optimum contact between the rubber roller 4 and the surface of the roller 2, pusher means are provided which are adapted to maintain the rubber roller 4 pressed against the surface of the roller 2.

Conveniently, said pusher means comprise at least one push rod and preferably two push rods, which are arranged at the ends of the rubber roller 4 and act on the shaft of said roller so as to apply a balanced pressure to the rubber roller, thus keeping it in abutment against the roller 2.

Advantageously, the push rods described above are constituted by an arc-like profiled element 5, to which a spring 6 is connected; the load of the spring is preadjustable and the arc-like element 5 abuts against the shaft of the rubber roller 4.

In this manner, by adjusting the preloading of the spring 6, one for each side of the rubber roller, it is possible to determine the pressure with which the rubber roller 4 makes contact with the anilox roller or rotogravure roller 2, so as to transfer an optimum quantity of ink to the cells 3 of the roller 2.

The closed doctor, the blades whereof are designated by the reference numeral 7, is designed to eliminate any excess ink, which then falls into the ink container 1.

In practice it has been found that the inking device according to the invention fully achieves the intended aim and objects, since it allows to have the rubber roller inside the closed doctor always in contact, with a selected pressure, with the anilox roller or rotogravure roller, accordingly improving the filling of the cells of the anilox roller or rotogravure roller as regards the quantity of ink dosed into said cells, regardless of the viscosity of the ink and of the printing speed. Moreover, the presence of air bubbles in the ink substantially has no influence on the final print, since the pressure applied by the rubber roller to the anilox roller allows to eliminate the presence of such bubbles.

The device thus conceived is susceptible of numerous modifications and variations, all of which are within the scope of the appended claims. Thus, for example, the adjustment of the rubber roller can be motorized, eliminating the push rod described earlier and using for example a gear. Moreover, all the details may be replaced with other technically equivalent elements.

In practice, the materials used, as well as the contingent shapes and dimensions, may be any according to requirements and to the state of the art.

The disclosures in Italian Patent Application No. MI2004A001693 from which this application claims priority are incorporated herein by reference.

What is claimed is:

1. An inking device for a printing roller for flexographic, rotogravure or offset printing, comprising an ink container with a closed doctor, and a printing roller onto which the ink is to be transferred from said ink container, comprising, within said ink container with closed doctor, a rubber roller, which is designed to make contact with said printing roller in order to transfer controlled doses of ink to cells formed on the surface of said printing roller.

2. The inking device according to claim 1, further comprising means adapted to keep said rubber roller pressed against the surface of said printing roller, in order to transfer controlled doses of ink to said cells formed on the surface of said printing roller.

3. The device according to claim 2, wherein said means adapted to keep said rubber roller pressed comprise at least one push rod, which is adapted to act on one end of a shaft of said rubber roller.

4. The device according to claim 3, further comprising two push rods, which are adapted to act on both ends of the shaft of the rubber roller.

5. The inking device according to claim 3, wherein said push rods comprise an arc-like element, which is connected to the end of a spring which is preloaded according to the requirements.
